(19) United States
(12) Patent Application Publication
(10) Pub. No.: US 2025/0363887 A1
(43) Pub. Date: Nov. 27, 2025

(54) THERMAL POWER PLANT TEMPERATURE VARIABLE ALARM PREDICTION METHOD AND SYSTEM BASED ON AMPLITUDE CHANGE TREND

(71) Applicant: SHANDONG UNIVERSITY OF SCIENCE AND TECHNOLOGY, Qingdao (CN)

(72) Inventors: Jiandong WANG, Qingdao (CN); Mengyao WEI, Qingdao (CN); Yizhou XU, Qingdao (CN); Ziyang MA, Qingdao (CN); Shouchen SUN, Qingdao (CN); Zijiang YANG, Qingdao (CN); Donghua ZHOU, Qingdao (CN)

(21) Appl. No.: 19/293,007

(22) Filed: Aug. 7, 2025

Related U.S. Application Data
(63) Continuation of application No. PCT/CN2024/075740, filed on Feb. 4, 2024.

(30) Foreign Application Priority Data
Feb. 15, 2023 (CN) 2023101129042

(51) Int. Cl. G08B 31/00

(52) U.S. Cl. CPC G08B 31/00

(57) ABSTRACT

The present disclosure provides a thermal power plant temperature variable alarm prediction method based on an amplitude change trend, comprising: acquiring historical data and current data of temperature variable at each measuring point of thermal power plant equipment; predicting probabilities that the temperature variable at each measuring point is in an alarm state, a non-alarm state, and an unknown state in future based on the historical data and the current data of the temperature variable at each measuring point; and obtaining a predicted probability that an amplitude uptrend data segment in the current data of the temperature variable at each measuring point triggers the alarm state and a confidence interval of the predicted probability according to the probabilities that the temperature variable at each measuring point is in alarm state, non-alarm state, and unknown state in future, and updating and displaying in real time in image user interface.

### CROSS-REFERENCE TO RELATED APPLICATIONS

The present disclosure claims priority to Chinese Patent Application No. 202310112904.2 filed to China National Intellectual Property Administration on Feb. 15, 2023, and entitled “Alarm State Prediction Method and System Based on Probability Inference of Amplitude Change Trend”, which is incorporated herein by reference in its entirety and constitutes a part of the present disclosure for all purposes.

### TECHNICAL FIELD

The present disclosure belongs to the technical field of alarm prediction for temperature variables monitored in real time in thermal power plants, and in particular to a thermal power plant temperature variable alarm prediction method and system based on an amplitude change trend.

### BACKGROUND

The description in this part only provides background technical information related to the present disclosure and does not necessarily constitute the prior art.

During an operation of a thermal power plant, there are numerous temperature-type monitoring variables. How to promptly and accurately trigger alarms based on monitoring data is critical for ensuring normal equipment operation, improving efficiency, extending equipment lifespan, and ensuring safe operation. When abnormal situations such as production abnormalities, equipment failures, and human errors occur, an alarm system generates an alarm signal, enabling an operator to take appropriate operational measures based on the alarm signals and avoid production losses caused by production abnormalities, equipment failures, etc.

In an actual production process, after production abnormalities, equipment failures, or human errors, etc., occur; the operator needs to respond promptly. If not promptly addressed, these abnormal situations may further deteriorate into major production accidents. However, there is often a significant difference between the actual occurrence time of these abnormal situations and the alarm triggering time, which severely reduces the response time available to the operator and easily leads to improper handling, resulting in severe economic losses and major production accidents.

Existing thermal power plant temperature variable alarm prediction methods may be broadly classified into time series modeling methods and time series classification methods. The time series modeling methods achieve alarm prediction by establishing time series regression models, neural network models, etc., for monitoring variables. The time series classification methods achieve alarm prediction by classifying the time series of monitoring variables into a non-alarm state and an alarm state. Although the two types of existing methods have certain rationality, they rely heavily on historical data in an alarm state as support, and lack reliability measures for alarm prediction results, leading to significant limitations in practical applications.

### SUMMARY

In order to solve at least one of the technical problems that temperature variables used as temperature type monitoring variables of thermal power plants often have change trends of obvious increase, no change, decrease and the like, and the change trends have statistical regularity in the background, the present disclosure provides a thermal power plant temperature variable alarm prediction method based on an amplitude change trend. Compared with the existing thermal power plant temperature variable alarm method, the present disclosure not only is applicable to situations where there are no alarm state data or only a small amount of alarm state data in historical data, but also can provide a reliability measure for an alarm state prediction result, thus having great significance to improving an application effect of an alarm system in production, reducing economic losses caused by production abnormalities, and avoiding major production accidents.

In order to realize the above purpose, the present disclosure adopts the following technical solution:

According to a first aspect, the present disclosure provides a thermal power plant temperature variable alarm prediction method based on an amplitude change trend, comprising:
acquiring historical data and current data of a temperature variable at each measuring point of thermal power plant equipment;
predicting probabilities that the temperature variable at each measuring point is in an alarm state, a non-alarm state, and an unknown state in future based on the historical data and the current data of the temperature variable at each measuring point, specifically comprising: respectively determining a number of elements less than an initial amplitude value and an amplitude change of an amplitude uptrend data segment in the current data based on an initial amplitude value set and an amplitude change set of amplitude uptrend data segments in the historical data of the temperature variable at each measuring point; estimating posterior probabilities that the initial amplitude value and the amplitude change of the amplitude uptrend data segment in the current data respectively trigger the alarm state and confidence intervals of the posterior probabilities by using a Bayesian estimation method based on the number of elements;
fusing probabilities that the initial amplitude value and the amplitude change of the amplitude uptrend data segment in the current data are in the alarm state, the non-alarm state, and the unknown state in future by adopting a Dempster-Shafer evidence theory based on the posterior probabilities and the confidence intervals of the posterior probabilities;
obtaining a predicted probability that the amplitude uptrend data segment in the current data of the temperature variable at each measuring point triggers the alarm state and a confidence interval of the predicted probability according to the probabilities that the temperature variable at each measuring point is in the alarm state, the non-alarm state, and the unknown state in future; and
analyzing physical values of an obtained predicted probability that the amplitude uptrend data segment in the current data of the temperature variable at each measuring point triggers the alarm state and upper and lower limits of the confidence interval of the predicted probability, and in a case that a predicted probability that an amplitude uptrend data segment in the current data of a temperature variable at a certain measuring point triggers the alarm state and physical values of upper and lower limits of a confidence interval of the predicted probability are greater than predefined thresholds, shutting down equipment at the measuring point, starting a standby unit, and planning maintenance of the equipment according to actual production needs.

As an implementation mode, the amplitude uptrend data segments in the historical data and the current data of the temperature variable at each measuring point are extracted by adopting a bottom-up piecewise linear representation method, specifically comprising dividing historical data and current data of an industrial monitoring variable into several sub-data segments, approximating each sub-data segment by using a straight line segment, and determining an amplitude uptrend data segment according to a trend calibration sequence of the straight line segment.

As an implementation mode, the initial amplitude value of the amplitude uptrend data segment is an amplitude of a first sample point of a piecewise linear representation result, and the amplitude change of the amplitude uptrend data segment is a difference between an amplitude of a last sample point and the amplitude of the first sample point of the piecewise linear representation result.

As an implementation mode, upper and lower limits of the confidence interval that the amplitude uptrend data segment in the current data reaches the alarm state are obtained by converting predicted probabilities that a current data segment reaches the alarm state and the non-alarm state.

As an implementation mode, the temperature variable at each measuring point of the thermal power plant equipment comprises generator stator temperature, boiler steam temperature, turbine pressure cylinder temperature, and main bearing temperature.

According to a second aspect, the present disclosure provides a thermal power plant temperature variable alarm prediction system based on an amplitude change trend, comprising:
a data acquisition module configured to acquire historical data and current data of a temperature variable at each measuring point of thermal power plant equipment;
an alarm probability prediction module configured to predict probabilities that the temperature variable at each measuring point is in an alarm state, a non-alarm state, and an unknown state in future based on the historical data and the current data of the temperature variable at each measuring point, specifically comprising:
respectively determining a number of elements less than an initial amplitude value and an amplitude change of an amplitude uptrend data segment in the current data based on an initial amplitude value set and an amplitude change set of amplitude uptrend data segments in the historical data of the temperature variable at each measuring point; estimating posterior probabilities that the initial amplitude value and the amplitude change of the amplitude uptrend data segment in the current data respectively trigger the alarm state and confidence intervals of the posterior probabilities by using a Bayesian estimation method based on the number of elements;
fusing probabilities that the initial amplitude value and the amplitude change of the amplitude uptrend data segment in the current data are in the alarm state, the non-alarm state, and the unknown state in future by adopting a Dempster-Shafer evidence theory based on the posterior probabilities and the confidence intervals of the posterior probabilities; and
an alarm information visualization module configured to obtain a predicted probability that the amplitude uptrend data segment in the current data of the temperature variable at each measuring point triggers the alarm state and a confidence interval of the predicted probability according to the probabilities that the temperature variable at each measuring point is in the alarm state, the non-alarm state, and the unknown state in future, and update and display in real time in an image user interface,
wherein, physical values of an obtained predicted probability that the amplitude uptrend data segment in the current data of the temperature variable at each measuring point triggers the alarm state and upper and lower limits of the confidence interval of the predicted probability are analyzed, and in a case that a predicted probability that an amplitude uptrend data segment in the current data of a temperature variable at a certain measuring point triggers the alarm state and physical values of upper and lower limits of a confidence interval of the predicted probability are greater than predefined thresholds, equipment at the measuring point are shut down, a standby unit is started, and maintenance of the equipment is planned according to actual production needs.

As an implementation mode, in the alarm probability prediction module, the amplitude uptrend data segments in the historical data and the current data of the temperature variable at each measuring point are extracted by adopting a bottom-up piecewise linear representation method, specifically comprising dividing historical data and current data of an industrial monitoring variable into several sub-data segments, approximating each sub-data segment by using a straight line segment, and determining an amplitude uptrend data segment according to a trend calibration sequence of the straight line segment.

As an implementation mode, in the alarm probability prediction module, the initial amplitude value of the amplitude uptrend data segment is an amplitude of a first sample point of a piecewise linear representation result, and the amplitude change of the amplitude uptrend data segment is a difference between an amplitude of a last sample point and the amplitude of the first sample point of the piecewise linear representation result.

As an implementation mode, in the alarm information visualization module, upper and lower limits of a confidence interval that the amplitude uptrend data segment in the current data reaches the alarm state are obtained by converting predicted probabilities that a current data segment reaches the alarm state and the non-alarm state.

As an implementation mode, in the data acquisition module, the temperature variable at each measuring point of the thermal power plant equipment comprises generator stator temperature, boiler steam temperature, turbine pressure cylinder temperature, and main bearing temperature.

Compared with the existing technology, the present disclosure has the following beneficial effects:

The method disclosed in the present disclosure not only is applicable to situations where there are no alarm state data or only a small amount of alarm state data in historical data, but also can provide a reliability measure for an alarm state prediction result, thus overcoming a shortcoming that the existing method relies on a large amount of historical data of the alarm state, and compensating for the lack of the reliability measure for the prediction result in the existing method, and having great significance to improving an application effect of an alarm system in production, reducing economic losses caused by production abnormalities, and avoiding major production accidents.

### BRIEF DESCRIPTION OF THE DRAWINGS

The drawings of the description, which form a part of the present disclosure, are intended to provide a further understanding of the present disclosure. The exemplary embodiments of the present disclosure and their descriptions are intended to describe the present disclosure, instead of constituting any improper limitation on the present disclosure.

FIG. 1 shows a flowchart of a thermal power plant temperature variable alarm prediction method based on an amplitude change trend according to Example 1 of the present disclosure.

FIG. 2 shows a trend curve of a non-driving-end bearing temperature variable of a coal mill in a thermal power plant under a normal condition according to Example 1 of the present disclosure.

FIG. 3A shows a current amplitude uptrend data segment of a non-driving-end bearing temperature variable of a coal mill in a thermal power plant under a c1 fault condition according to Example 1 of the present disclosure.

FIG. 3B shows a current amplitude uptrend data segment of a non-driving-end bearing temperature variable of a coal mill in a thermal power plant under a c2 fault condition according to Example 1 of the present disclosure.

FIG. 3C shows a current amplitude uptrend data segment of a non-driving-end bearing temperature variable of a coal mill in a thermal power plant under a c3 fault condition according to Example 1 of the present disclosure.

FIG. 4 shows a complete temperature trend curve of a non-driving-end bearing temperature variable of a coal mill in a thermal power plant under a fault condition according to Example 1 of the present disclosure.

FIG. 5 shows a scatter plot of an initial amplitude value and an amplitude change of an amplitude uptrend data segment of a temperature variable according to Example 1 of the present disclosure.

FIG. 6 shows a simulation diagram of a thermal power plant temperature variable alarm prediction system based on an amplitude change trend according to Example 11 of the present disclosure.

### DETAILED DESCRIPTION

The present disclosure will be further described below in combination with the embodiments with reference to the drawings.

It should be pointed out that the following detailed descriptions are exemplary and intended to provide further description of the present disclosure. Unless otherwise specified, all technical and scientific terms used herein have the same meanings as those commonly understood by an ordinary person skilled in the art to which the present disclosure belongs.

It is to be noted that the terms used herein are only for describing specific embodiments and are not intended to limit exemplary embodiments according to the present disclosure. As used here, unless otherwise explicitly stated in the context, the singular form is also intended to comprise the plural form. In addition, it should be understood that when the terms “comprising” and/or “comprising” are used in this description, they indicate the existence of features, steps, operations, devices, components, and/or combinations thereof.

During an operation of a thermal power plant, there is numerous temperature type monitoring variables. Promptly and accurately monitoring them is critical for ensuring a normal operation of equipment, improving efficiency, extending equipment lifespan, and ensuring safe operation. Taking generator stator temperature as an example, it is a critical parameter, and monitoring it helps to detect a possible overload or heat dissipation problem. Taking boiler steam temperature as an example, a temperature of steam generated by a boiler is monitored to ensure that it is within an appropriate range, so as to maintain a high-efficiency power generation process. Taking turbine high-pressure, medium-pressure and low-pressure cylinder temperature as an example, the temperature of each pressure cylinder of a turbine is monitored to ensure that it is within a normal operating range. Finally, taking main bearing temperature as an example, main bearing temperatures of equipment such as coal mills, fans, and generators are a critical monitoring parameter. By monitoring these data, equipment damage caused by bearing overheating can be avoided.

### EXAMPLE 1

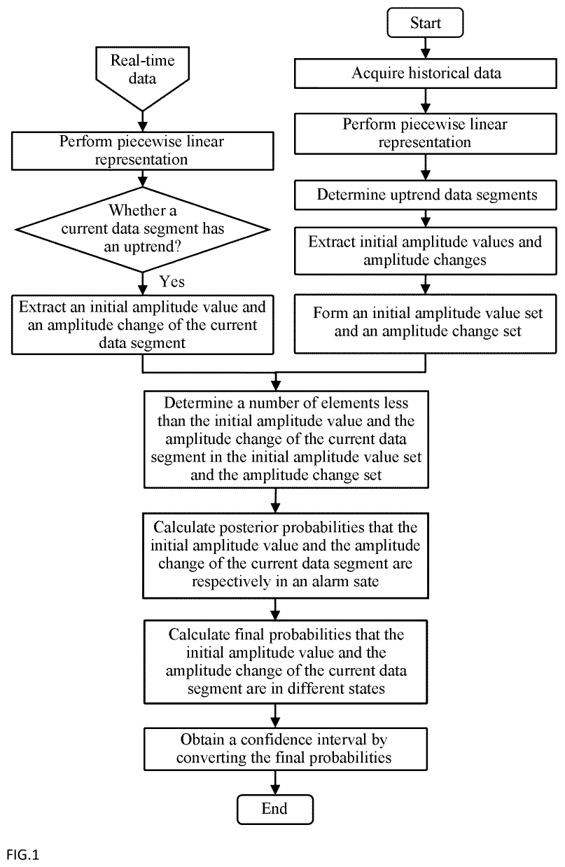

As shown in FIG. 1, the present example provides a thermal power plant temperature variable alarm prediction method based on an amplitude change trend, which comprises:
S1: acquiring historical data and current data of a monitored temperature variable;
S2: extracting an amplitude uptrend data segment of the monitored temperature variable in the historical data and the current data by adopting a piecewise linear representation method;
S3: estimating a posterior probability that the temperature variable triggers an alarm state in future and a confidence interval of the posterior probability according to an initial amplitude value and an amplitude change of the amplitude uptrend data segment in the current data by using a Bayesian estimation method based on the amplitude uptrend data segments of the temperature variable in the historical data and the current data;
S4: fusing probabilities that the initial amplitude value and the amplitude change of the amplitude uptrend data segment in the current data are in the alarm state, a non-alarm state, and an unknown state in future by adopting a Dempster-Shafer evidence theory to obtain a predicted probability that the amplitude uptrend data segment in the current data triggers the alarm state and a confidence interval of the predicted probability; and
S5: analyzing physical values of an obtained predicted probability that the amplitude uptrend data segment in the current data of a temperature variable at each measuring point triggers the alarm state and upper and lower limits of the confidence interval of the predicted probability, and in a case that a predicted probability that an amplitude uptrend data segment in the current data of a temperature variable at a certain measuring point triggers the alarm state and physical values of upper and lower limits of a confidence interval of the predicted probability are greater than predefined thresholds, shutting down equipment at the measuring point, starting a standby unit, and planning maintenance of the equipment according to actual production needs.

In S1, historical data and current data of a temperature variable at each measuring point are acquired through data acquisition equipment mounted at each measuring point during an operation of a thermal power plant; and
the data acquisition equipment installed at the measuring point monitors the measuring point at a fixed frequency, and transmits data in real time and stores the data in a data server through communication protocols; a client transmits a data request to the data server through a protocol interface; and after the data server receives the data request from the client, it will return requested data according to requirements, the client stores received data locally to form a local historical database, and the client requests real-time data from the server regularly.

The historical data and the current data of the temperature variable are acquired from the server; and the historical data are acquired from the server and stored to form local historical data x(1:Tₕ), and current data x_{c}(1:T_{c}) are acquired. In S2, the amplitude uptrend data segment of the monitored temperature variable in the historical data and the current data is extracted by adopting a bottom-up piecewise linear representation method.

Specifically, historical data x(1:Tₕ) with a length of Tₕ are converted into N trend data segments

$${\{ \hat{x} ( {t}_{i} : {t}_{i + 1} - 1 ) \}}_{i = 1}^{N}$$

by adopting a bottom-up linear piecewise representation method, and an amplitude uptrend data segment in

$${\{ \hat{x} ( {t}_{i} : {t}_{i + 1} - 1 ) \}}_{i = 1}^{N}$$

is determined. The amplitude uptrend data segment \hat{x}_{c}(t₀:T_{c}) is extracted from cached current data x_{c}(1:T_{c}) by adopting the same method and steps.

It specifically comprises:
S21: converting the historical data x(1:Tₕ) into a data segment set

$${\{ \hat{x} ( {t}_{i} : {t}_{i + 1} - 1 ) \}}_{i = 1}^{N}$$

that may be represented by a straight line segment, where an ith data segment \hat{x}(tᵢ:tᵢ₊₁−1) may be represented as:

$$\hat{x} ( t ) = {a}_{i} + {b}_{i} \cdot t , t = 1 , 2 , … , {t}_{i + 1} - {t}_{i} , \qquad ( 1 )$$

wherein, aᵢ and bᵢ are respectively an intercept and a slope of an approximate straight line segment, and specific values of aᵢ and bᵢ are respectively:

$${a}_{i} = \frac{{\sum }_{t = {t}_{i}}^{{t}_{i + 1} - 1} {t}^{2} {\sum }_{t = {t}_{i}}^{{t}_{i + 1} - 1} \hat{x} ( t ) - {\sum }_{t = {t}_{i}}^{{t}_{i + 1} - 1} t {\sum }_{t = {t}_{i}}^{{t}_{i + 1} - 1} t \hat{x} ( t )}{( {t}_{i + 1} - {t}_{i} ) {\sum }_{t = {t}_{i}}^{{t}_{i + 1} - 1} {t}^{2} - {( {\sum }_{t = {t}_{i}}^{{t}_{i + 1} - 1} t )}^{2}} ;$$

$${b}_{i} = \frac{{\sum }_{t = {t}_{i}}^{{t}_{i + 1} - 1} t \hat{x} ( t ) - {\sum }_{t = {t}_{i}}^{{t}_{i + 1} - 1} t {\sum }_{t = {t}_{i}}^{{t}_{i + 1} - 1} \hat{x} ( t )}{( {t}_{i + 1} - {t}_{i} ) {\sum }_{t = {t}_{i}}^{{t}_{i + 1} - 1} {t}^{2} - {( {\sum }_{t = {t}_{i}}^{{t}_{i + 1} - 1} t )}^{2}} .$$

S22: determining an amplitude uptrend data segment in

$${\{ \hat{x} ( {t}_{i} : {t}_{i + 1} - 1 ) \}}_{i = 1}^{N}$$

according to a trend calibration sequence I(\hat{x}(tᵢ:tᵢ₊₁−1)), wherein I(\hat{x}(tᵢ:tᵢ₊₁−1)) is defined as:

$$I ( \hat{x} ( {t}_{i} : {t}_{i + 1} - 1 ) ) = \{ \begin{matrix}1 , & \hat{x} ( {t}_{i + 1} - 1 ) - \hat{x} ( {t}_{i} ) > {A}_{0} \\ 0 , & other\end{matrix} , \qquad ( 2 )$$

wherein, A₀ is an amplitude change threshold, valued is:

$${A}_{0} = \sqrt{\frac{12 {R}_{0}^{2} {\hat{σ}}^{2}}{1 - {R}_{0}^{2}}} ,$$

wherein, R₀ is the minimum acceptable coefficient of determination, calculated according to:

$${R}_{0}^{2} = max ( 0 , min ( 1 , 1 - \frac{{{\sum }_{i = 1}^{N} [ x ( {t}_{i} : {t}_{i + 1} - 1 ) - \hat{x} ( {t}_{i} : {t}_{i + 1} - 1 ) ]}^{2}}{{\hat{σ}}^{2}} ) ) , \qquad ( 3 )$$

and \hat{σ}² is an estimated value of a noise variance, calculated according to:

$${\hat{σ}}^{2} = \frac{1}{N} {\sum }_{i = 1}^{N} \frac{{[ x ( {t}_{i} : {t}_{i + 1} - 1 ) - \hat{x} ( {t}_{i} : {t}_{i + 1} - 1 ) ]}^{2}}{{t}_{i + 1} - {t}_{i}} , \qquad ( 4 )$$

and the obtained K^{th} amplitude uptrend data segment is:

$${\{ {\hat{x}}_{u} ( {t}_{k} : {t}_{k + 1} - 1 ) \}}_{k = 1}^{K} := {\{ \hat{x} ( {t}_{i} : {t}_{i + 1} - 1 ) \vert \hat{x} ( {t}_{i} : {t}_{i + 1} - 1 ) \}}_{i = 1}^{N} . \qquad ( 5 )$$

S23: performing piecewise linear representation on the current data segment x_{c}(1:T_{c}) in a cache according to formula (1) to formula (5), performing a next step in a case that the current data segment of the temperature variable is an amplitude uptrend data segment and is denoted as \hat{x}_{c}(t₀:T_{c}), otherwise, continuously putting new real-time data into the cache, and repeating the above steps.

In S3, the estimating a posterior probability that the temperature variable triggers an alarm state in future and a confidence interval of the posterior probability according to an initial amplitude value and an amplitude change of the amplitude uptrend data segment in the current data by using a Bayesian estimation method based on the amplitude uptrend data segments of the monitored temperature variable in the historical data and the current data specifically comprises:

S31: obtaining an initial amplitude value x_{0,k} and an amplitude change x_{Δ,k} of each amplitude uptrend data segment in the historical data based on the amplitude uptrend data segment in the historical data

$${\{ {\hat{x}}_{u} ( {t}_{k} : {t}_{k + 1} - 1 ) \}}_{k = 1}^{K} ,$$

which are:

$${x}_{0 , k} = {\hat{x}}_{u} ( {t}_{k} ) , \qquad ( 6 )$$

$${x}_{Δ , k} = {\hat{x}}_{u} ( {t}_{k + 1} - 1 ) - {\hat{x}}_{u} ( {t}_{k} ) . \qquad ( 7 )$$

These respectively denoting all initial values x_{0,k} and changes x_{Δ,k} as sets

$${\{ {x}_{0 , k} \}}_{k = 1}^{K} and {\{ {x}_{Δ , k} \}}_{k = 1}^{K} .$$

Similarly, obtaining an initial amplitude value x_{0,c} and an amplitude change x_{Δ,c} of each amplitude uptrend data segment \hat{x}_{c}(t₀:T_{c}) of the temperature variable in the current data.

S32: determining elements that the initial amplitude value

$${\{ {x}_{0 , k} \}}_{k = 1}^{K}$$

and the amplitude change

$${\{ {x}_{Δ , k} \}}_{k = 1}^{K}$$

or the amplitude uptrend data segment in the historical data are respectively less than x_{0,c} and x_{Δ,c} based on the initial amplitude value

$${\{ {x}_{0 , k} \}}_{k = 1}^{K}$$

and the amplitude change

$${\{ {x}_{Δ , k} \}}_{k = 1}^{K}$$

of the amplitude uptrend data segment in the historical data and in combination with the initial value x_{0,c} and the change x_{Δ,c} of the amplitude uptrend data segment \hat{x}(t₀:T_{c}) of the temperature variable in the current data, and obtaining posterior probabilities that x_{0,c} and x_{Δ,c} trigger an alarm state X₁ and confidence intervals of the posterior probabilities through Bayesian estimation according to a number of these elements.

In S32, the obtaining posterior probabilities that x_{0,c} and x_{Δ,c} trigger an alarm state X₁ and confidence intervals of the posterior probabilities through Bayesian estimation specifically comprises:

for ease of expression, allowing C₁=x_{0,c} and C₂=x_{Δ,c}, and adopting Cᵥ for unified representation, wherein v=1,2; denoting the alarm state in future as X₁, and adopting θᵥ to represent a probability of X₁ obtained based on Cᵥ, so a prior probability of θᵥ is p(θᵥ) and a posterior probability may be obtained through Bayesian estimation:

$$p ( {θ}_{v} \vert {C}_{v} ) = \frac{p ( {C}_{v} \vert {θ}_{v} ) p ( {θ}_{v} )}{p ( {C}_{v} )} , v = 1 , 2. \qquad ( 8 )$$

Then, determining a conditional probability p(Cᵥ|θᵥ) and probability values p(Cᵥ) and p(0ᵥ) in formula (8). The number K₁ of elements less than x_{0,c} in

$${\{ {x}_{0 , k} \}}_{k = 1}^{K}$$

may be determined according to:

$${K}_{1} = {\sum }_{i = 1}^{K} \vert sgn ( {x}_{0 , c} - {x}_{0 , k} ) ≡ 1 \vert , \qquad ( 9 )$$

wherein, the function sgn(·) is:

$$sgn ( x ) = \{ \begin{matrix}1 , & x > 0 \\ - 1 , & x \leq 0\end{matrix} . \qquad ( 10 )$$

Similarly, the number K₂ of elements less than x_{Δ,c} in

$${\{ {x}_{Δ , k} \}}_{k = 1}^{K}$$

may be determined according to:

$${K}_{2} = {\sum }_{i = 1}^{K} \vert sgn ( {x}_{Δ , c} - {x}_{Δ , k} ) ≡ 1 \vert . \qquad ( 11 )$$

Since a future state (alarm state or non-alarm state) of the current amplitude uptrend data segment \hat{x}_{c}(t₀:T_{c}) is a discrete random variable that follows a binomial distribution, the conditional probability p(Cᵥ|θᵥ) in formula (8) is:

$$p ( {C}_{v} \vert {θ}_{v} ) = C ( K , {K}_{v} ) {{θ}_{v}^{{K}_{v}} ( 1 - {θ}_{v} )}^{K - {K}_{v}} , \qquad ( 12 )$$

$$wherein ,$$

$$C ( K , {K}_{v} ) = \frac{K !}{{K}_{v} ! ( K - {K}_{v} ) !} .$$

The probability p(Cᵥ) may be calculated by using a total probability formula, which is:

$$p ( {C}_{v} ) = {\int }_{0}^{1} p ( {C}_{v} \vert {θ}_{v} ) p ( {θ}_{v} ) d {θ}_{v} . \qquad ( 13 )$$

Here, due to the lack of prior knowledge about p(θᵥ), p(θᵥ) may be regarded as a uniform distribution on the interval [0,1]. In formula (8), the reliability of the posterior probability p(θᵥ|Cᵥ) is measured by a confidence interval [pₗ(θᵥ; K), pᵤ(θᵥ;K)] with a confidence level of (1−α). Upper and lower limits of the confidence interval are determined according to:

$$min ( {p}_{u} ( {θ}_{v} ; K ) - {p}_{l} ( {θ}_{v} ; K ) ) satisfying {\int }_{{p}_{l} ( {θ}_{v} ; K )}^{{p}_{u} ( {θ}_{v} ; K )} p ( {θ}_{v} \vert {C}_{v} ) d {θ}_{v} = 1 - α . \qquad ( 14 )$$

In S3, the initial amplitude value of the amplitude uptrend data segment is an amplitude of a first sample point of a piecewise linear representation result, and the amplitude change of the amplitude uptrend data segment is a difference between an amplitude of a last sample point and the amplitude of the first sample point of the piecewise linear representation result.

In S4, the fusing probabilities that the initial amplitude value x_{0,c} and the amplitude change x_{Δ,c} of the amplitude uptrend data segment \hat{x}_{c}(t₀:T_{c}) of the temperature variable in the current data are in an alarm state X₁, a non-alarm state X₀, and an unknown state X₂ in future by adopting a Dempster-Shafer evidence theory to obtain a predicted probability that the amplitude uptrend data segment of the monitored variable in the current data triggers the alarm state and a confidence interval of the predicted probability specifically comprises:
S41: determining probabilities that the initial amplitude value and the amplitude change of the current amplitude uptrend data segment \hat{x}_{c}(t₀:T_{c}) are in an alarm state X₁, a non-alarm state X₀, and an unknown state X₂ in future,
wherein, since the lower limit of the confidence interval [pₗ(θᵥ; K), pᵤ(θᵥ; K)] represents the probability that the current data segment is in the alarm state in future, the probabilities that the initial amplitude value and the amplitude change of the data segment \hat{x}_{c}(t₀:T_{c}) are in the non-alarm state X₀ and the alarm state X₁ in future are:

$${p}_{v} ( {X}_{1} ) = {p}_{l} ( {θ}_{v} ; K ) , \qquad ( 15 )$$

$${p}_{v} ( {X}_{0} ) = 1 - {p}_{u} ( {θ}_{v} ; K ) .$$

And, since a width of the confidence interval is a representation of the uncertainty of a prediction result, the probability that the current data segment is in the unknown state X₂ in future is:

$${p}_{v} ( {X}_{2} ) = {p}_{u} ( {θ}_{v} ; K ) - {p}_{l} ( {θ}_{v} ; K ) . \qquad ( 16 )$$

S42: fusing the probabilities p₁(Xⱼ) and p₂(Xⱼ) obtained from formula (15) and formula (16) according to a Dempster-Shafer evidence theory to obtain a predicted probability p(Xⱼ), j=0,1,2, that \hat{x}_{c}(t₀:T_{c}) reaches each state, the specific fusion rule comprising:

$$p ( {X}_{1} ) = \frac{{p}_{1} ( {X}_{1} ) \cdot {p}_{2} ( {X}_{1} ) + {p}_{1} ( {X}_{1} ) \cdot {p}_{2} ( {X}_{2} ) + {p}_{1} ( {X}_{2} ) \cdot {p}_{2} ( {X}_{1} )}{1 - λ} , \qquad ( 17 )$$

$$p ( {X}_{0} ) = \frac{{p}_{1} ( {X}_{0} ) \cdot {p}_{2} ( {X}_{0} ) + {p}_{1} ( {X}_{0} ) \cdot {p}_{2} ( {X}_{2} ) + {p}_{1} ( {X}_{2} ) \cdot {p}_{2} ( {X}_{0} )}{1 - λ} ,$$

$$p ( {X}_{2} ) = \frac{{p}_{1} ( {X}_{2} ) \cdot {p}_{2} ( {X}_{2} )}{1 - λ} ,$$

wherein, the parameter λ is a conflict factor, valued is:

$$λ = {p}_{1} ( {X}_{1} ) \cdot {p}_{2} ( {X}_{0} ) + {p}_{1} ( {X}_{0} ) \cdot {p}_{2} ( {X}_{1} ) . \qquad ( 18 )$$

If the confidence interval of the predicted probability of the alarm state is denoted as [pₗ(X₁), pᵤ(X₁)], then p(X₁) in formula (17) is the lower limit pₗ(X₁) of the interval.

From formula (17), it can be seen that p(X₂) is proportional to p₁(X₂)·p₂(X₂). Therefore, the upper limit of the interval is pᵤ (X₁)=p(X₁)+p(X₂).

Therefore, the confidence interval of the predicted probability that \hat{x}_{c}(t₀:T_{c}) triggers the alarm state is:

$$[ {p}_{l} ( {X}_{1} ) , {p}_{u} ( {X}_{1} ) ] = [ p ( {X}_{1} ) , p ( {X}_{1} ) + p ( {X}_{2} ) ] . \qquad ( 19 )$$

Similarly, the confidence interval of the predicted probability that the current amplitude uptrend data segment triggers the non-alarm state is:

$$[ {p}_{l} ( {X}_{0} ) , {p}_{u} ( {X}_{0} ) ] = [ p ( {X}_{0} ) , p ( {X}_{0} ) + p ( {X}_{2} ) ] . \qquad ( 20 )$$

The above step is to estimate the probabilities that the temperature variable reaches the alarm state, the non-alarm state, and the unknown state in future according to the initial amplitude value and the amplitude change of the current data segment by adopting a Dempster-Shafer evidence theory. Here, upper and lower limits of the confidence interval that the amplitude uptrend data segment in the current data reaches the alarm state are obtained by converting the predicted probabilities p(Xⱼ) that the current data segment \hat{x}_{c}(t₀:T_{c}) reaches the alarm state and the non-alarm state.

The unknown state is a state introduced to describe the uncertainty of the prediction result regarding to triggering the alarm state. At the same time, the introduction of the unknown state solves the problem that the sum of probabilities is not equal to 1 when the initial amplitude value and the amplitude change are respectively in the alarm state and the non-alarm state.

For ease of understanding, the following is an actual numerical example based on non-driving-end bearing temperature of a coal mill in a thermal power plant.

In order to improve a coal combustion efficiency in a large thermal power plant, raw coal in a coal hopper of a machine is firstly conveyed to a coal mill to be ground into pulverized coal, then the pulverized coal is blown into a pulverized coal discharge fan through a conveyor belt under the drive of hot air, and finally it enters a furnace of a boiler for combustion. Therefore, the coal mill is heavy auxiliary equipment in the thermal power plant. It has great significance to achieve high-temperature prediction and alarm for the non-driving end bearing temperature of the coal mill in the thermal power plant. A prediction and alarm system can detect an abnormal situation before the bearing temperature rises to a dangerous level, so as to help operation and maintenance personnel to detect potential problems in advance. High temperature may cause bearing damage and equipment failure. By triggering an alarm promptly, measures can be taken to stop equipment operation, reduce a degree of damage, and extend equipment lifespan. If the bearing temperature exceeds a normal range, the system may need to be shut down for maintenance, resulting in production interruption. Through prediction and alarm, a reasonable maintenance plan can be made and a standby unit can be started in advance to avoid sudden shutdown.

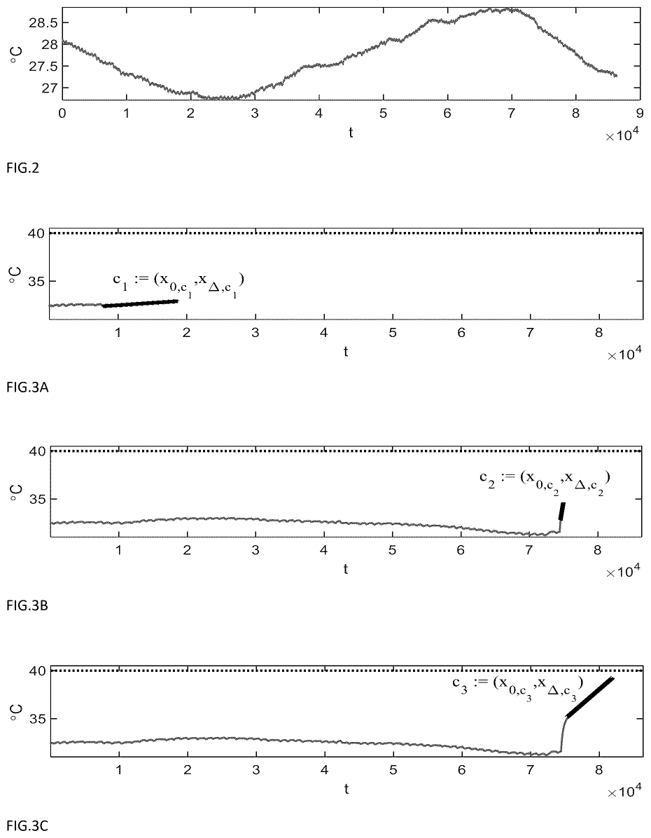

FIG. 2 shows a 24-hour trend curve of non-driving-end bearing temperature of the coal mill in the thermal power plant under a normal condition. Main faults that may occur during the operation of the coal mill comprise coal mill vibration, coal blockage, and bearing overheating.

In the present example, the actual historical data of the non-driving-end bearing temperature of the coal mill in the thermal power plant are used, and the non-driving-end bearing temperature data of the coal mill for 35 days are selected according to a cycle of one day.

Based on actual data, the alarm prediction method provided in the present example will be further described, and specific steps are as follows:

In step 1, piecewise linear representation is performed on all historical data of the bearing temperature x of the coal mill according to formula (1) to formula (4), and 149 amplitude uptrend data segments comprised therein are determined according to formula (5).

In step 2, initial amplitude values x_{0,k} and amplitude changes x_{Δ,k} of these amplitude uptrend data segments are obtained through formula (6) and formula (7) and denoted as

$${\{ {x}_{0 , k} \}}_{k = 1}^{149} and {\{ {x}_{Δ , k} \}}_{k = 1}^{149} .$$

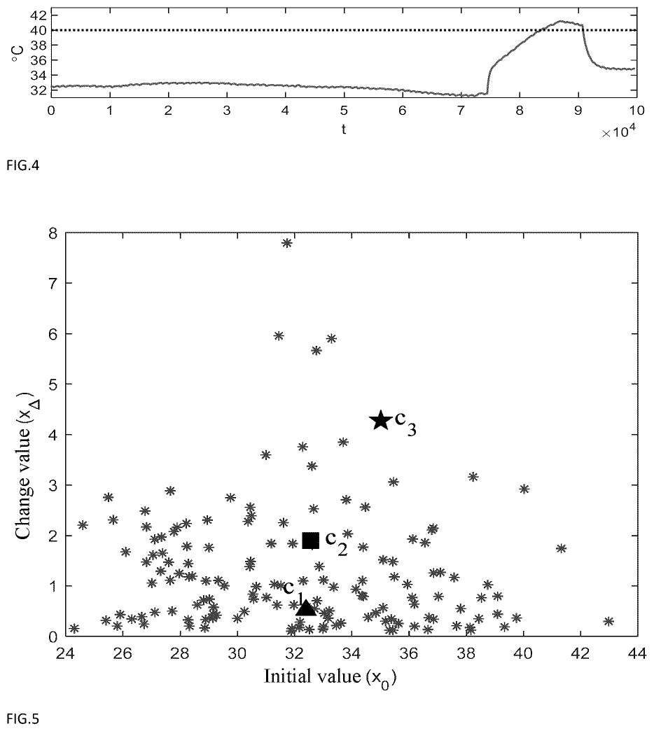

A scatter plot of two-dimensional sample points (x_{0,k}, x_{Δ,k}) composed of all initial values and changes is as shown in FIG. 5. Then, data of a new day are taken as a current data segment x_{c}(1:T_{c}), the obtained x_{c}(1:T_{c}) is as shown in FIG. 3A, and a current amplitude uptrend data segment of the temperature variable is obtained by using a piecewise linear representation method, and an initial amplitude value and an amplitude change of the current data segment obtained are as shown by point c₁ (triangle) in FIG. 5. The number of samples less than x_{0,c1} in set

$${\{ {x}_{0 , k} \}}_{k = 1}^{149}$$

is 77, and the number of samples less than x_{Δ,c1} in set

$${\{ {x}_{Δ , k} \}}_{k = 1}^{149}$$

is 49. Based on these data, a predicted probability that \hat{x}_{c}(t₀:T_{c}) triggers the alarm state and a confidence interval of the predicted probability are obtained through formula (8), formula (17), formula (19), and formula (20), as shown in Table 1.

TABLE 1
Predicted probability that c₁ triggers an alarm state
and confidence interval of the predicted probability

| State (Xⱼ) | p₁(Xⱼ) | p₂(Xⱼ) | p(Xⱼ) | Confidence interval |
|---|---|---|---|---|
| Alarm state (X₁) | 0.4372 | 0.2571 | 0.3432 | [0.3432, 0.3804] |
| Non-alarm state (X₀) | 0.4042 | 0.5936 | 0.6196 | [0.6196, 0.6568] |
| Unknown state (X₂) | 0.1587 | 0.1493 | 0.0372 | |

In Table 1, the predicted probability that the current data segment triggers the alarm state X₁ is very low. This is because compared to historical data, both x_{0,c1} and x_{Δ,c1} are not very large, especially x_{0,c1} is less than most x_{0,k}. Therefore, the change corresponding to c₁ is more likely to be caused by noise rather than certain faults. This is verified in subsequent simulation, that is, as the simulation duration increases, \hat{x}_{c}(t₀:T_{c}) does not enter the alarm state.

In step 3, in a monitoring process, a fault occurs in the bearing temperature variable, and a simulation sequence obtained is as shown in FIG. 3B. The current data of the temperature variable have an amplitude uptrend data segment, with an initial amplitude value of x_{0,c2}=32.5578° C. and an amplitude change of x_{Δ,c2}=1.8994° C. In sets

$${\{ {x}_{0 , k} \}}_{k = 1}^{149} and {\{ {x}_{Δ , k} \}}_{k = 1}^{149} ,$$

the number of samples less than x_{0,c2} and x_{Δ,c2} is 81 and 114, respectively. Although a comparison result between x_{0,c2} and x_{0,k} are not significantly different from that between x_{0,c1} and x_{0,k}, the number of samples obtained from x_{Δ,c2} compared with x_{Δ,k} is significantly increased.

Therefore, p₁(X₁)=0.4638 in Table 2 is close to p₂(X₁)=0.4372 in Table 1, but p₂(X₁)=0.6932 in Table 2 is much greater than p₂(X₁)=0.2571 in Table 1. Table 2 provides a predicted probability that \hat{x}_{c}(t₀:T_{c}) triggers the alarm state and a confidence interval, where the probability of triggering the alarm state is 0.7501, indicating that \hat{x}_{c}(t₀:T_{c}) possibly triggers the alarm state.

TABLE 2
Predicted probability that c₂ triggers an alarm state
and confidence interval of the predicted probability

| State (Xⱼ) | p₁(Xⱼ) | p₂(Xⱼ) | p(Xⱼ) | Confidence interval |
|---|---|---|---|---|
| Alarm state (X₁) | 0.4638 | 0.6932 | 0.7501 | [0.7501, 0.7825] |
| Non-alarm state (X₀) | 0.3780 | 0.1719 | 0.2175 | [0.2175, 0.2499] |
| Unknown state (X₂) | 0.1582 | 0.1349 | 0.0324 | |

The subsequent simulation result verifies the above inference, and a corresponding time series curve is as shown in FIG. 3C. In this case, the number of samples less than x_{0,c3} and x_{Δ,c3} in sets

$${\{ {x}_{0 , k} \}}_{k = 1}^{149} and {\{ {x}_{Δ , k} \}}_{k = 1}^{149} ,$$

is 119 and 141, respectively, and the probability that \hat{x}_{c}(t₀:T_{c}) triggers the alarm state is 0.7557, indicating that the current time series is highly likely to generate the alarm state. According to the simulation result shown in FIG. 4, the current data segment x_{c}(1:T_{c}) has indeed exceeded a high alarm threshold xₜₚ=40° C.

It should be noted that the present example is described by taking the monitoring variable configured with the high alarm threshold and the amplitude uptrend thereof only as an example. If the monitoring variable is configured with a low alarm threshold, the proposed method is also applied by changing the uptrend to the downtrend.

### EXAMPLE 2

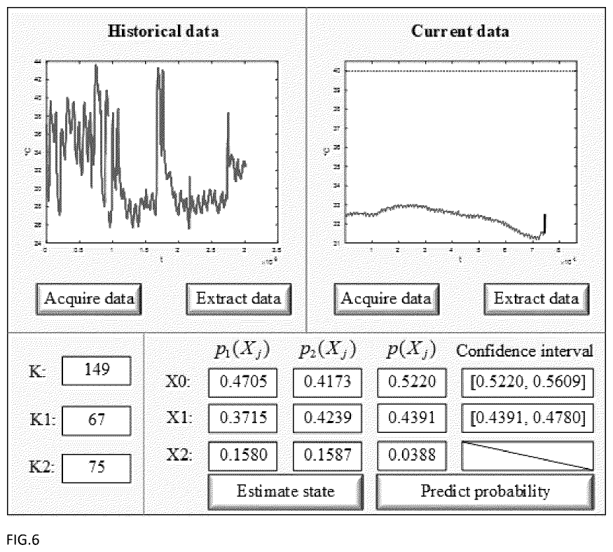

Referring to FIG. 6, the present example provides a thermal power plant temperature variable alarm prediction system based on an amplitude change trend, comprising:
a data acquisition module configured to acquire historical data and current data of a temperature variable at each measuring point of thermal power plant equipment;
an alarm probability prediction module configured to predict probabilities that the temperature variable at each measuring point is in an alarm state, a non-alarm state, and an unknown state in future based on the historical data and the current data of the temperature variable at each measuring point, specifically comprising: respectively determining a number of elements less than an initial amplitude value and an amplitude change of an amplitude uptrend data segment in the current data based on an initial amplitude value set and an amplitude change set of amplitude uptrend data segments in the historical data of the temperature variable at each measuring point; estimating posterior probabilities that the initial amplitude value and the amplitude change of the amplitude uptrend data segment in the current data respectively trigger the alarm state and confidence intervals of the posterior probabilities by using a Bayesian estimation method based on the number of elements;
fusing probabilities that the initial amplitude value and the amplitude change of the amplitude uptrend data segment in the current data are in the alarm state, the non-alarm state, and the unknown state in future by adopting a Dempster-Shafer evidence theory based on the posterior probabilities and the confidence intervals of the posterior probabilities; and
an alarm information visualization module configured to obtain a predicted probability that the amplitude uptrend data segment in the current data of the temperature variable at each measuring point triggers the alarm state and a confidence interval of the predicted probability according to the probabilities that the temperature variable at each measuring point is in the alarm state, the non-alarm state, and the unknown state in future, and update and display in real time in an image user interface,
wherein, physical values of an obtained predicted probability that the amplitude uptrend data segment in the current data of the temperature variable at each measuring point triggers the alarm state and upper and lower limits of the confidence interval of the predicted probability are analyzed, and in a case that a predicted probability that an amplitude uptrend data segment in the current data of a temperature variable at a certain measuring point triggers the alarm state and physical values of upper and lower limits of a confidence interval of the predicted probability are greater than predefined thresholds, equipment at the measuring point are shut down, a standby unit is started, and maintenance of the equipment is planned according to actual production needs.

In the alarm probability prediction module, the amplitude uptrend data segments in the historical data and the current data of the temperature variable at each measuring point are extracted by adopting a bottom-up piecewise linear representation method, specifically comprising dividing historical data and current data of an industrial monitoring variable into several sub-data segments, approximating each sub-data segment by using a straight line segment, and determining an amplitude uptrend data segment according to a trend calibration sequence of the straight line segment.

In the alarm probability prediction module, the initial amplitude value of the amplitude uptrend data segment is an amplitude of a first sample point of a piecewise linear representation result, and the amplitude change of the amplitude uptrend data segment is a difference between an amplitude of a last sample point and the amplitude of the first sample point of the piecewise linear representation result.

In the alarm information visualization module, upper and lower limits of a confidence interval that the amplitude uptrend data segment in the current data reaches the alarm state are obtained by converting predicted probabilities that a current data segment reaches the alarm state and the non-alarm state.

In the data acquisition module, the temperature variable at each measuring point of the thermal power plant equipment comprises generator stator temperature, boiler steam temperature, turbine pressure cylinder temperature, and main bearing temperature.

What are described above are only exemplary embodiments of the present disclosure and are not intended to limit the present disclosure. For those skilled in the art, the present disclosure may have various modifications and variations. Any modifications, equivalent replacements, improvements and the like made within the spirit and principle of the present disclosure shall be comprised within the scope of protection of the present disclosure.

1. A method for predicting alarm states based on inferring from probabilities of amplitude change trends, comprising the following steps:
acquiring historical data and current data of industrial monitoring variables;
extracting amplitude uptrend data segments of the industrial monitoring variables in the historical data and the current data by using piecewise linear representation method;
respectively obtaining corresponding initial amplitude value and amplitude change on the basis of the amplitude uptrend data segments of the industrial monitoring variables in the historical data and the current data;
respectively determining a quantity of elements that are smaller than the initial amplitude value and the amplitude changes of the amplitude uptrend data segments in the current data on the basis of a set of the initial amplitude value and a set of the amplitude changes of the amplitude uptrend data segments in the historical data; estimating posterior probabilities of the initial amplitude values and the amplitude changes of the amplitude uptrend data segments in the current data that trigger an alarm state respectively and confidence intervals thereof, by using Bayesian estimation method; and
fusing, by using Dempster Shafer evidence theory, probabilities of the initial amplitude value and the amplitude changes in the amplitude uptrend data segments in the current data being in an alarm state, a non-alarm state, and an unknown state in future on the basis of the posterior probabilities and the confidence intervals thereof, and obtaining predicted probabilities of the amplitude uptrend data segments of the current data that trigger the alarm state and confidence intervals thereof through conversion.

2. The method for predicting alarm states based on inferring from probabilities of amplitude change trends according to claim 1, wherein extracting the amplitude uptrend data segments of the industrial monitoring variables in the historical data and the current data by using a bottom-up piecewise linear representation method,, specifically is, dividing the amplitude uptrend data segments of the industrial monitoring variables in the historical data and the current data into several sub-data segments, and each of the sub-data segments is approximated by a straight line segment.

3. The method for predicting alarm states based on inferring from probabilities of amplitude change trends according to claim 1, wherein the initial amplitude value of the amplitude uptrend data segments is an amplitude of a first sample point of a piecewise linear representation result, and the amplitude change of the amplitude uptrend data segments is a difference between an amplitude of a last sample point and the amplitude of the first sample point of the piecewise linear representation result.

4. The method for predicting alarm states based on inferring from probabilities of amplitude change trends according to claim 1, wherein upper and lower limits of a confidence interval that an amplitude uptrend data segment in the current data reaches the alarm state are converted from prediction probabilities that a current data segment reaches the alarm state and the non-alarm state.

5. A system for predicting alarm states based on inferring from probabilities of amplitude change trends, comprising:
a data acquisition module, being configured for acquiring historical data and current data of industrial monitoring variables;
a data segment extraction module, being configured for extracting amplitude uptrend data segments of the industrial monitoring variables in the historical data and the current data by using piecewise linear representation method;
an alarm state estimation module, being configured for
respectively obtaining corresponding initial amplitude value and amplitude change on the basis of the amplitude uptrend data segments of the industrial monitoring variables in the historical data and the current data;
respectively determining a quantity of elements that are smaller than the initial amplitude value and the amplitude changes of the amplitude uptrend data segments in the current data on the basis of a set of the initial amplitude value and a set of the amplitude changes of the amplitude uptrend data segments in the historical data; estimating posterior probabilities of the initial amplitude values and the amplitude changes of the amplitude uptrend data segments in the current data that trigger an alarm state respectively and confidence intervals thereof, by using Bayesian estimation method; and
an amplitude change trend probability inference module, being configured for fusing, by using Dempster Shafer evidence theory, probabilities of the initial amplitude value and the amplitude changes in the amplitude uptrend data segments in the current data being in an alarm state, a non-alarm state, and an unknown state in future on the basis of the posterior probabilities and the confidence intervals thereof, and obtaining predicted probabilities of the amplitude uptrend data segments of the current data that trigger the alarm state and confidence intervals thereof through conversion.

6. The system for predicting alarm states based on inferring from probabilities of amplitude change trends according to claim 5, wherein in data segment extraction module, extracting the amplitude uptrend data segments of the industrial monitoring variables in the historical data and the current data by using a bottom-up piecewise linear representation method,, specifically is, dividing the amplitude uptrend data segments of the industrial monitoring variables in the historical data and the current data into several sub-data segments, and each of the sub-data segments is approximated by a straight line segment.

7. The system for predicting alarm states based on inferring from probabilities of amplitude change trends according to claim 5, wherein in the alarm state estimation module, the initial amplitude value of the amplitude uptrend data segments is an amplitude of a first sample point of a piecewise linear representation result, and the amplitude change of the amplitude uptrend data segments is a difference between an amplitude of a last sample point and the amplitude of the first sample point of the piecewise linear representation result.

8. The system for predicting alarm states based on inferring from probabilities of amplitude change trends according to claim 5, wherein in the amplitude change trend probability inference module, upper and lower limits of a confidence interval that an amplitude uptrend data segment in the current data reaches the alarm state are converted from prediction probabilities that a current data segment reaches the alarm state and the non-alarm state.
